(19) United States
(12) Patent Application Publication
(10) Pub. No.: US 2011/0218933 A1
(43) Pub. Date: Sep. 8, 2011

(54) Method and Apparatus for Managing Mobile Storage

(76) Inventors: Theodore Thomas Hunsaker, Avondale, AZ (US); Christopher George Bierman, Thatcher, AZ (US); Daysha Donelson-Myers, Laveen, AZ (US); Michael David Gallagher, Scottsdale, AZ (US)

(21) Appl. No.: 13/042,360

(22) Filed: Mar. 7, 2011

Related U.S. Application Data
(60) Provisional application No. 61/310,829, filed on Mar. 5, 2010.

(51) Int. Cl. G06Q 10/00; G01C 21/00

(52) U.S. Cl. 705/338

(57) ABSTRACT

A computer system for managing and operating a mobile storage business includes a centralized database that stores route information for a plurality of drivers and routes. A mobile computer device can be used by a driver or mobile storage representative to communicate with the database. The device can be used to display route information relating to the delivery or pickup of a portable storage container and to transmit to the database the signature of the customer, comments relating to the task, images relating to the task and location associated with the container identifier. The mobile computer device includes a scanner for capturing the container identification and a global positioning system capability for capturing the location associated with the container and the location of the mobile computer device.

### RELATED APPLICATION

This application claims the benefit of U.S. Provisional Application No. 61/310,829, filed Mar. 5, 2010, entitled “Method and Apparatus for Managing Mobile Storage,” which is incorporated herein by reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

This invention relates to methods and systems for managing and providing moving storage services. More particularly, it relates to a method and system for managing and providing such services involving portable storage containers.

A number of companies provide mobile or portable self-storage services, including delivery, pick-up and storage of portable storage containers. In such a mobile self-storage business, personnel are required to manage customer orders for portable storage containers, process transactions regarding such containers, schedule and perform the delivery of the portable containers to customers, schedule and perform the pick-up of such containers from customers and arrange for and perform storage and movement of the portable containers.

It is an object of the present invention to provide a method and system for to facilitate the operation of such a mobile self-storage business.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY

To achieve the foregoing objects, and in accordance with the purposes of the invention as embodied and broadly described in this document, there is provided a method and system for managing and providing mobile storage services. The method includes using a mobile computer device to display delivery vehicle driver route information relating to the delivery or pickup of a portable storage container. The route information can include: contact information associated with a customer on the route, including a customer address for delivery of the storage container; a task associated with the customer; a task status associated with customer; and map information including information showing the location of the customer address. The method also can include: using the mobile computer device to display for the customer contract information related to the task; using the mobile device to capture a signature of the customer to acknowledge the customer's agreement to the displayed contract information; using the mobile device to capture comments relating to the task; using the mobile device to capture images related to the task; using the mobile device to capture a container identifier associated with the portable storage container; and using the mobile device to capture a location associated with the container identifier.

According to one aspect of the invention, the mobile computer device is used to transmit to a centralized database the signature of the customer, the comments relating to the task, the images relating to the task, and the location associated with the container identifier. The centralized database can store route information for a plurality of drivers and a plurality of routes.

According to another aspect of the invention, the mobile computer device includes a barcode scanner for capturing the container identifier and a global positioning system capability for capturing the location associated with the container and the location of the mobile computer device.

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a functional block diagram of a preferred computer system and a network for practicing the present invention, including a self-storage management computer system and mobile computer devices.

FIG. 2 is a block diagram showing the functionality of a mobile storage computer application program stored on the mobile computer device and its interaction with a self-storage management application program, according to the present invention.

FIG. 3 shows an exemplary screen display of an information page of a website according to the present invention, which page provides information on portable storage containers and services that customers can order via the website.

FIG. 4 shows an exemplary screen display of a reservations page of the website, which customers can use to request reservations for portable storage containers and services according to the invention.

FIG. 5 shows an exemplary screen display of a shopping cart page of the website, showing a customer's requested reservation for delivery of a portable storage container.

FIG. 6 shows an exemplary screen display of a checkout page of the website, showing a summary of a customer's order for delivery of a portable storage container.

FIG. 7 shows an exemplary screen display of a Sign-In page of the website, through which a customer can sign in to the website to view, change or cancel an existing order.

FIG. 8 shows an exemplary screen display of a Scheduling interface for use by a system administrator or dispatcher in scheduling and managing delivery and pickup of portable storage containers according to the present invention.

FIG. 9 shows an exemplary Applications Menu page displayed on the screen of the mobile computer device, from which a driver or mobile storage representative can launch a mobile storage application program according to the present invention.

FIG. 10 shows an exemplary Login page displayed on the screen of the mobile computer device.

FIG. 11 shows an exemplary Login page displayed on the screen of the mobile computer device for user login when the user can do so in different capacities with different authorizations.

FIG. 12 shows an exemplary Customer Main page displayed on the screen of the mobile computer device and showing scheduled deliveries and pickups for a selected route of a driver who is logged into the device.

FIG. 13 shows an exemplary Customer Details page displayed on the screen of the mobile computer device for accessing options for completing a scheduled delivery or pickup, taking photographs, making notes, obtaining the customer's signature and scanning barcode identifiers on portable storage containers.

FIG. 14 shows an exemplary Customer Acknowledgment page displayed on the screen of the mobile computer device, showing contract terms and conditions for the customer to review and acknowledge.

FIG. 15 shows an exemplary Signature page displayed on the screen of the mobile computer device for obtaining a customer's signature.

FIG. 16 shows an exemplary Comments page displayed on the screen of the mobile computer device for entering and viewing comments regarding a customer's transaction.

FIG. 17 shows an exemplary Images page displayed on the screen of the mobile computer device for taking digital images relating to a transaction.

FIG. 18 shows the Images page of FIG. 17 displaying stored images that have been taken with the mobile computer device.

FIG. 19 shows an exemplary Customer Details page displayed on the screen of the mobile computer device with all transaction comments, signatures, and images completed.

FIG. 20 shows an exemplary Enter/Scan Box No. page displayed on the screen of the mobile computer device for capturing a storage container identifier.

FIG. 21 shows an exemplary Menu page displayed on the screen of the mobile computer device.

FIG. 22 shows an exemplary Drop a Box page displayed on the screen of the mobile computer device for tracking the delivery a portable storage container to a non-customer location.

FIG. 23 shows an exemplary Select Location page displayed on the screen of the mobile computer device for selecting a location from a list of stored locations.

FIG. 24 shows an exemplary Custom Location page displayed on the screen of the mobile computer device for inputting information about a location that is not included in the list of stored locations.

FIG. 25 shows an exemplary Select a Route page displayed on the screen of the mobile computer device for selecting one of multiple routes scheduled for a given delivery driver for a given day.

FIG. 26 shows an exemplary Accident Reporting page 440 displayed on the screen of the mobile computer device for reporting incidents involving portable storage containers or delivery vehicles.

FIG. 27 shows an exemplary Route Map page displayed on the screen of the mobile computer device showing a map of a driver's route in the current day's schedule.

FIG. 28 shows an exemplary Warehouse Menu page displayed on the screen of the mobile computer device for facilitating the tracking, loading, unloading and moving of portable storage containers at a storage warehouse.

FIG. 29 shows an exemplary Scan Box to Be Loaded page displayed on the screen of the mobile computer device for capturing and displaying identifiers of portable storage containers to be loaded on a truck.

FIGS. 30-31 show displays of the Scan Box to Be Loaded page illustrating its use as the portable storage container is loaded on the truck.

FIG. 32 shows an exemplary Scan Box to Unload page displayed on the screen of the mobile computer device for capturing and displaying identifiers of a portable storage containers to be unloaded from a truck.

FIG. 33 shows an exemplary Warehouse Location page displayed on the screen of the mobile computer device for capturing the warehouse location of a portable storage containers unloaded from a truck.

FIG. 34 shows an exemplary Scan Box page displayed on the screen of the mobile computer device for tracking the movement of a portable storage container within a warehouse.

FIG. 35 shows an exemplary Successful Move page displayed on the screen of the mobile computer device for notifying a user after a container has been moved that the warehouse space inventory information has been successfully updated.

### DESCRIPTION

Reference will now be made in more detail to presently preferred embodiments of the invention. While the invention is described more fully with reference to these examples, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

According to the present invention, a mobile computer device is used as part of a computer network to help manage and operate a mobile storage business. The mobile computer device can be used by a driver or mobile storage representative during his or her daily routine to communicate with a self-storage management computer system that is also part of the network. The self-storage management system provides portable storage personnel with access to tools and information that facilitate tracking and management of customer reservations and orders for portable storage containers, scheduling and performing delivery of portable containers to customers and pick-up of such containers from customers, and tracking the movement and storage of portable storage containers (including their movement within a storage warehouse) in addition to other tasks that were previously either not available to such personnel or were far more difficult to accomplish. The mobile computer device provides functionality for accessing delivery route and task information, locating and interacting with customers, obtaining customer acknowledgments and signatures, recording comments relating to a transaction, capturing digital images relating to a transaction, capturing storage container identifiers, and capturing and tracking location information for portable storage containers.

### Computer Network System

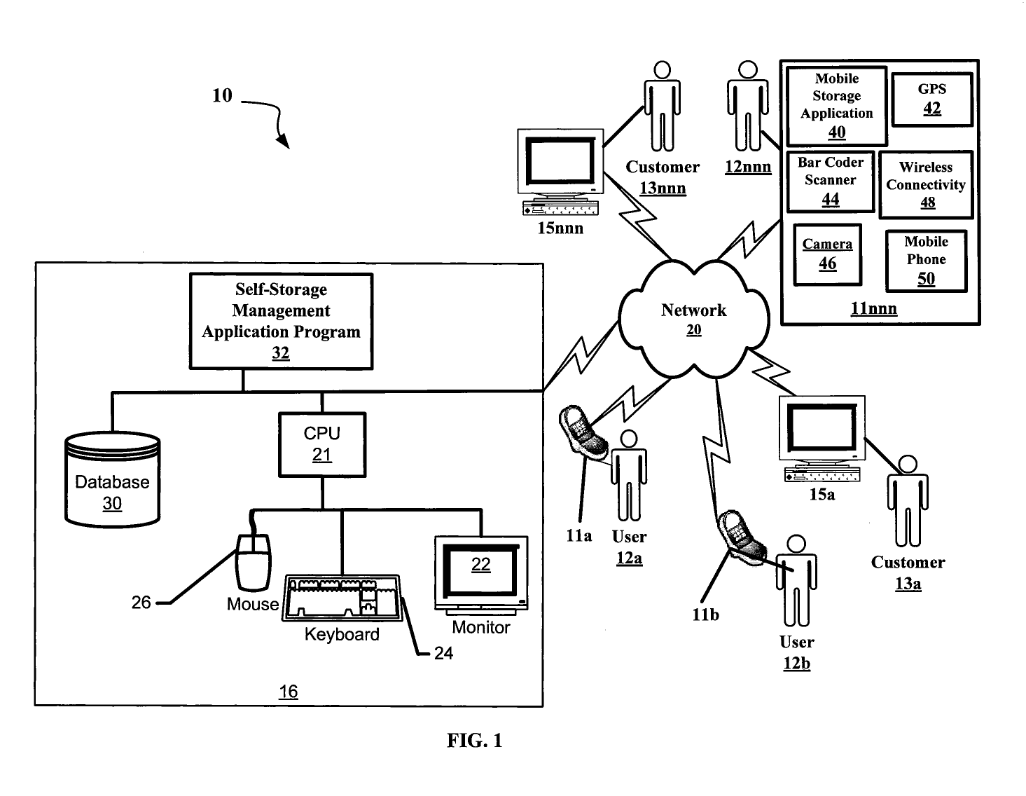

FIG. 1 illustrates a preferred computer network system 10 for practicing the present invention. The computer network system 10 includes a self-storage management computer system 16, which stores and processes the information described below for managing orders for portable storage containers, processing transactions regarding such containers, scheduling and performing the delivery of the portable containers to customers, scheduling and perform the pick-up of such containers from customers and arranging for and perform storage and movement of the portable containers, such as within a storage warehouse. Mobile users 12—including mobile storage representatives or drivers who pick up and deliver portable self-storage containers—can access and communicate with the mobile storage management computer system 16 via mobile computer devices 11a, 11b and 11nnn, (where nnn refers to any number of users and user devices) coupled to the mobile storage management computer system 16 via a computer network 20, such as the Internet, or by other suitable communications means. In addition, in a presently preferred embodiment, mobile storage customers 13a-13nnn can submit reservation requests or orders for portable storage containers via vendor computers 15a-15nnn coupled to the computer system 16 via the computer network 20. In a preferred embodiment of the invention, the computer network 20 comprises the Internet. Upon reading this specification, those skilled in the art will understand that, under appropriate circumstances, considering issues such as developments in computer hardware, software and connectivity, etc., other network configurations and devices also may suffice.

Still referring to FIG. 1, the self-storage reservation and management computer system 16 includes a central processing unit (CPU) 21 for processing data and program instructions. The mobile storage computer system 16 also includes input and output devices, as is well known in the art. For example, the self-storage reservation and management computer system 16 preferably includes a display screen or monitor 22, a keyboard 24, a mouse 26, a printer (not shown), etc. The self-storage reservation and management computer system 16 further includes data storage and memory devices, as are known in the art, for storing a database 30. The database 30 is used to store customer data, delivery and pickup scheduling data and other mobile storage data required by the mobile storage application of the mobile computer device 11 to provide the functionality described below. Preferably, the database 30 is a relational database, as is well known in the art. A mobile storage management application program 32 is operable with the database 30 and the mobile computer device 11 to provide the functionality described below. In a presently preferred embodiment, the self-storage management application program 32 is written using Active Server Pages (ASP) server-side scripting technology and the .NET software framework, marketed by Microsoft Corporation of Redmond, Wash. The database 30 is implemented using the SQL Server database management system, both also marketed by Microsoft Corporation. Upon reading this specification, those skilled in the art will understand that, under appropriate circumstances, considering issues such as developments in computer hardware, software and connectivity, etc., other operating systems, programming languages and database management systems can be used.

The mobile computer device 11 can store and run application programs, including a mobile storage application 40, which communicates with the self-storage reservation and management computer system 16 as described below. In a preferred embodiment, the mobile computer device 11 also includes a global positioning system (GPS) program 42, a bar code scanner 44, a digital camera 46, wireless connectivity 48 and a mobile telephone 50. One suitable mobile computer device, which includes all of these features, is the MC75 3G Worldwide Enterprise Digital Assistant device marketed by Motorola, Inc. of Schaumberg, Ill. Application programs for this device can be written in the C# programming language using Microsoft Windows Mobile development tools such as those in the Microsoft Visual Studio development environment. In a preferred embodiment, the mobile computer device 11 stores and runs the mobile storage application program 40, which includes functionality for communicating with the storage management application program 32 and the database 30.

### Operation of the System

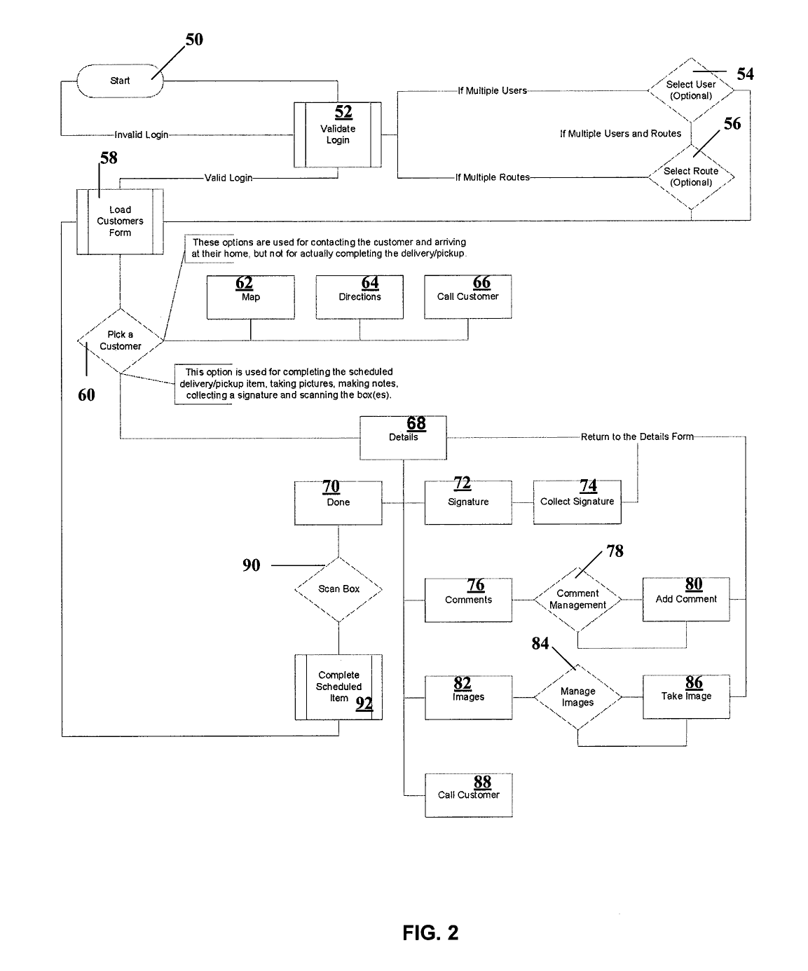

FIG. 2 illustrates the functionality of the mobile computer device 11 and its interaction with the self-storage management computer system 16, according to the present invention. Once a mobile device user 12, such as a driver or mobile storage representative, has been set up as an authorized user in the self-storage management computer system 16, the user can start the mobile storage computer application 40 on the mobile computer device 11 (step 50) and login to the system using his or her credentials (e.g., username and password). If the user can log into the self-storage management computer system 16 in different capacities with different authorizations, e.g. as a driver or as a developer, the user must select the desired login authorization (step 54). If a user is assigned multiple delivery routes for a given day, the user must select the desired route for viewing (step 56).

After the self-storage management computer system 16 validates the login (step 52) and any authorization and route options are selected (steps 54 and 56), the mobile computer device 11 accesses information stored in the database 30 that is associated with the logged-in user, including stored information relating to customers and tasks associated with one the selected route assigned to the logged-in user. The storage management application program 31 downloads this information to the mobile computer device 11 for display on that device (step 58). The mobile device user 12 can then select a customer (step 60) and perform various functions with the mobile computer device 11 to assist with locating and communicating with that customer, including display a map showing the location of the customer's address (step 62), displaying directions from the current location to the customer's address (step 64) or calling the customer using the mobile telephone 50 of the mobile computer device 11 (step 66).

Still referring to FIG. 2, the mobile device user 12 can select a Details function (step 68) to access more detailed information for customers and tasks on the selected route. The user also is able to access a Signature function (step 72) for collecting the customer's signature (step 74), a Comments function (step 76) for viewing and adding comments related to the transaction with a the customer (steps 78 and 80), an Images function (step 82) for taking and storing digital images related to the customer transaction, and a Call Customer function (step 88) for contacting the customer using the mobile telephone feature of the mobile computer device 11.

After all transaction comments, signatures, and images have been completed, the user 12 can finalize the transaction by selecting a Done function (step 70). This runs a Scan Box function (step 90), which prompts the user to scan or manually enter a bar-coded identifier number on the subject portable storage. After the container number is entered, the scheduled transaction is completed (step 92), the captured information can be uploaded to the mobile storage management computer system 16 and the mobile computer device 11 again displays the route information (step 58).

### Customer Interface

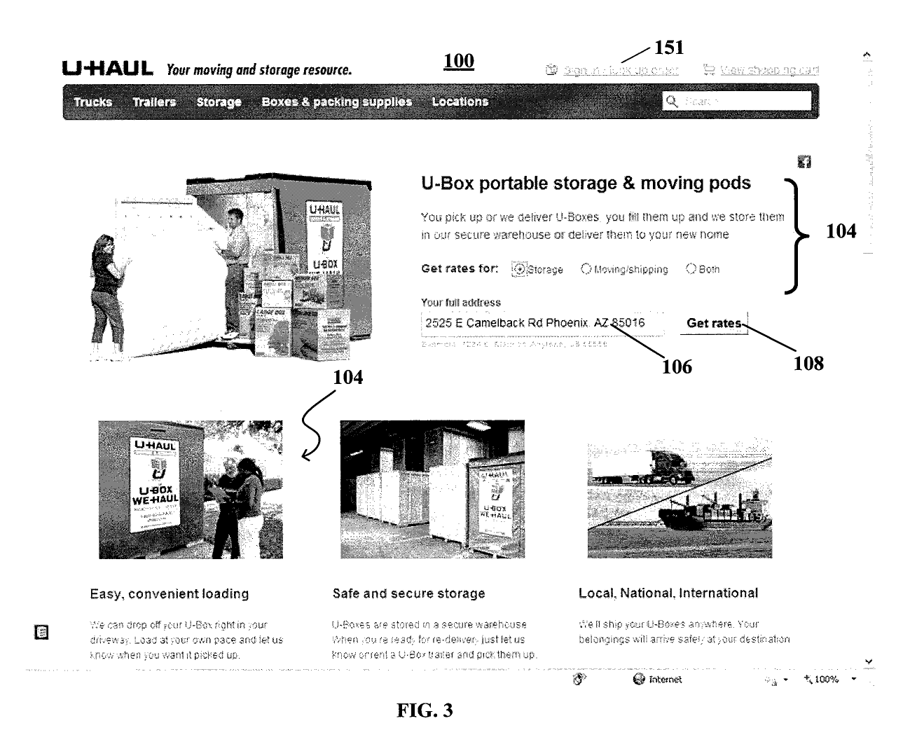

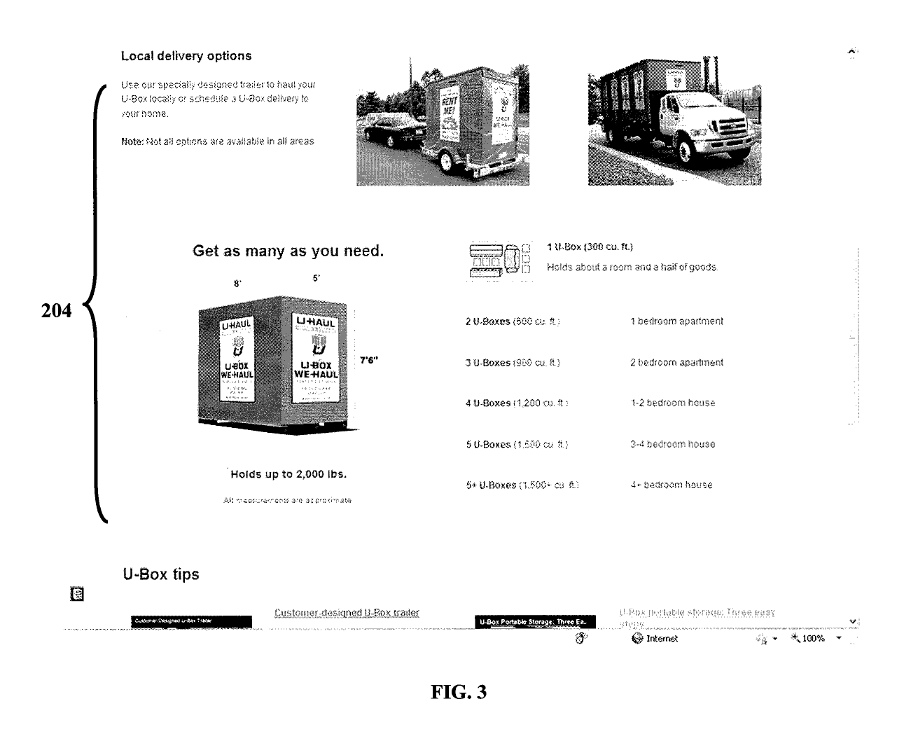

FIGS. 3-7 show exemplary web pages that are served by the mobile storage computer system 16 to the customer computers 15 and through which customers can view and purchase mobile storage services, including requesting a reservation of a portable self-storage container. Data entered via this customer interface also can be captured and used in connection with a self-storage reservation and management system, such as that described in U.S. patent application Ser. No. 10/087,193 entitled “Automated Self-Storage Reservation and Management System” and having Publication No. US 2006/0206342, which is incorporated herein in its entirety by this reference.

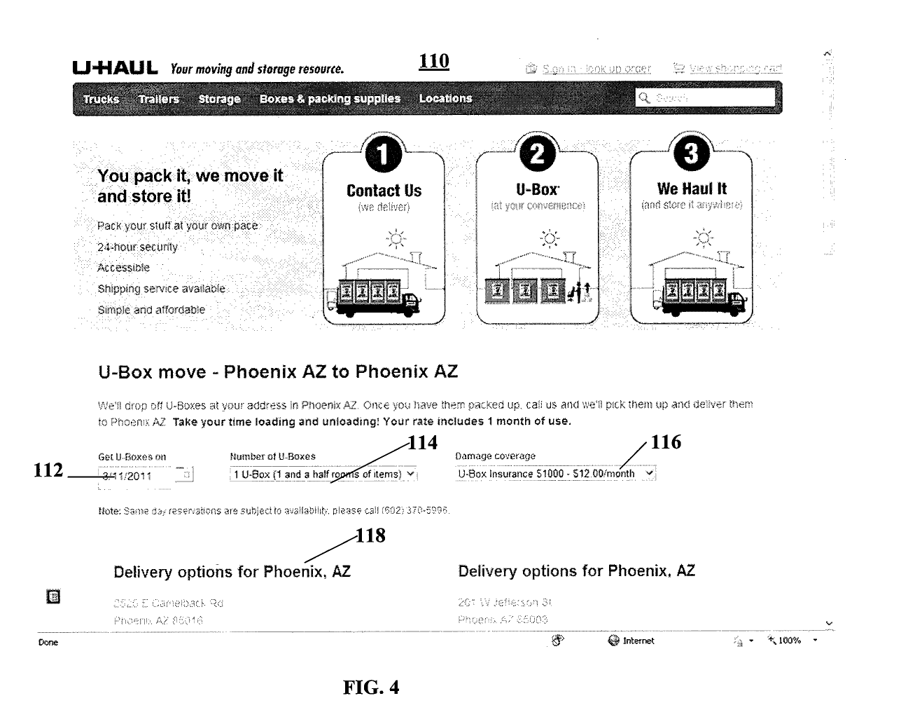

FIG. 3 shows an exemplary display of a public Home page 100 that is served by the self-storage reservation and management computer system 16 to the customer computer 15. The Home page 100 includes a customer navigation menu 102 for navigating the self-storage public website and displays information regarding the portable storage services and products that the customer 13 can purchase. The Home page 100 includes information on pick up and delivery of portable storage containers 104, an address field 106 and a Rates link 108. When the customer 13 enters a delivery address into the address field 106 and selects the Rates link 108, the self-storage reservation and management computer system 16 displays a Reservation page 110, such as that shown in FIG. 4, with which the customer 13 can reserve a portable storage unit for delivery to the entered address and can provide contact information, such as telephone numbers.

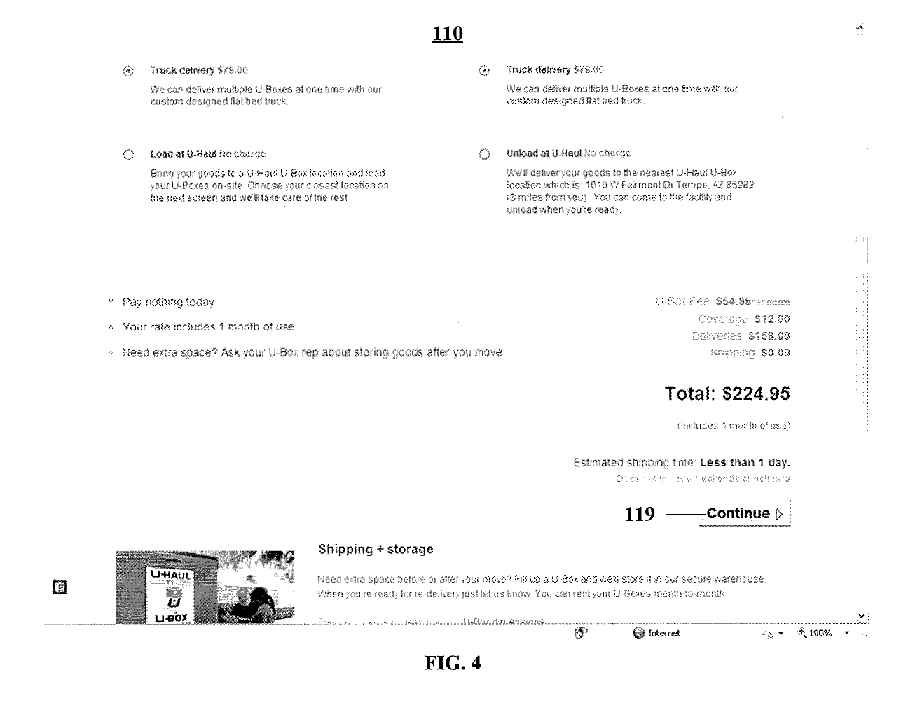

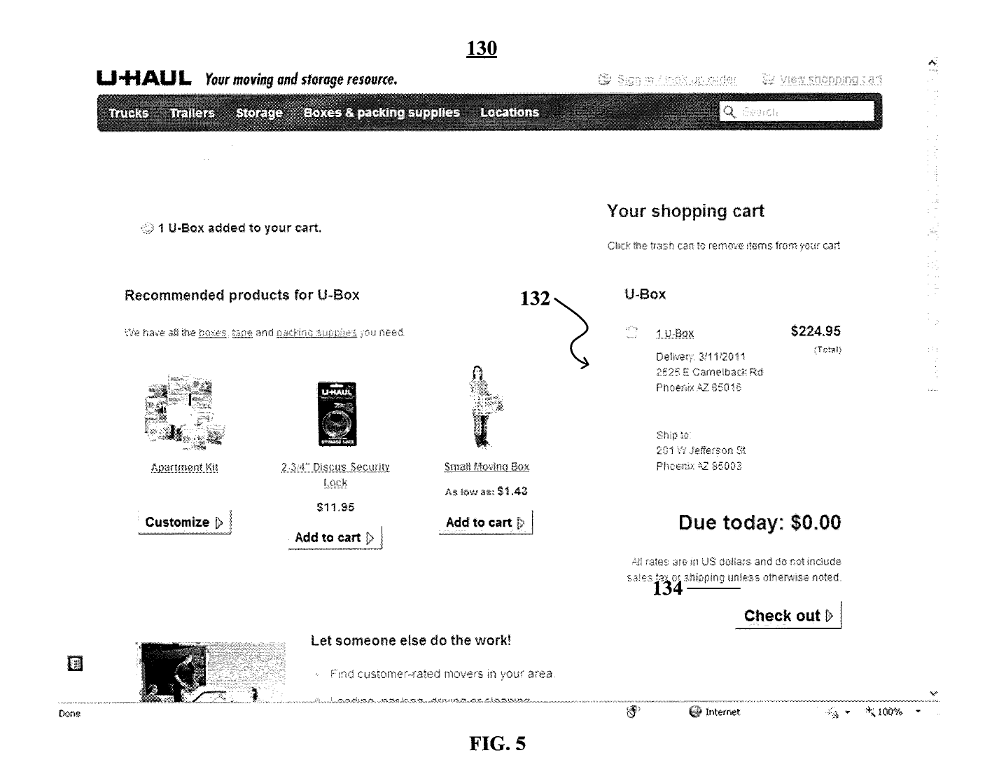

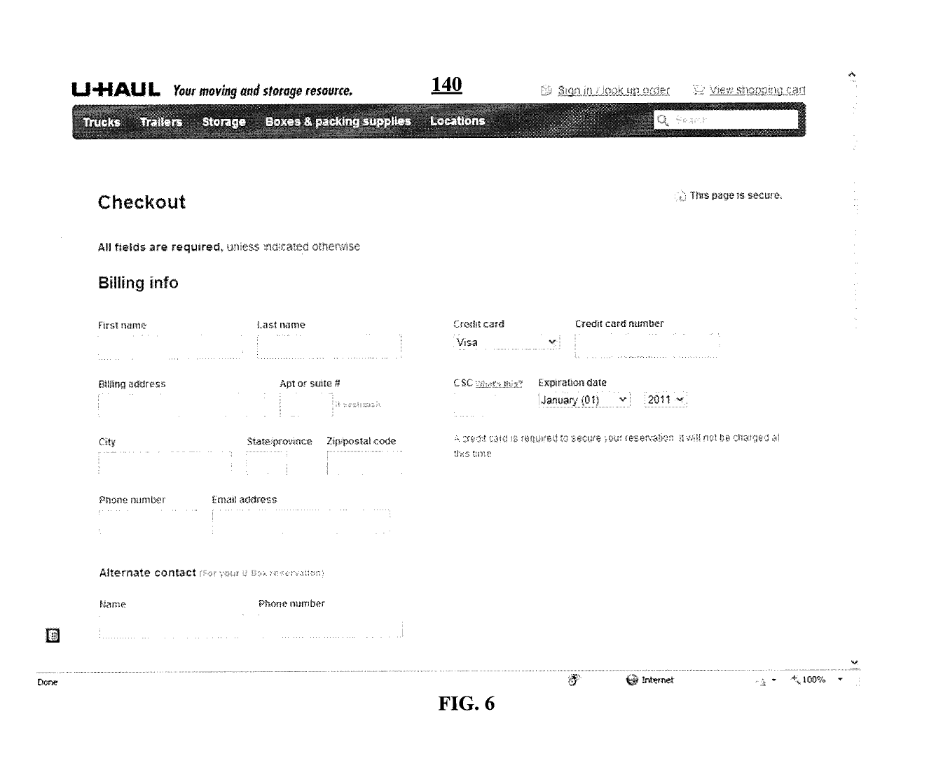

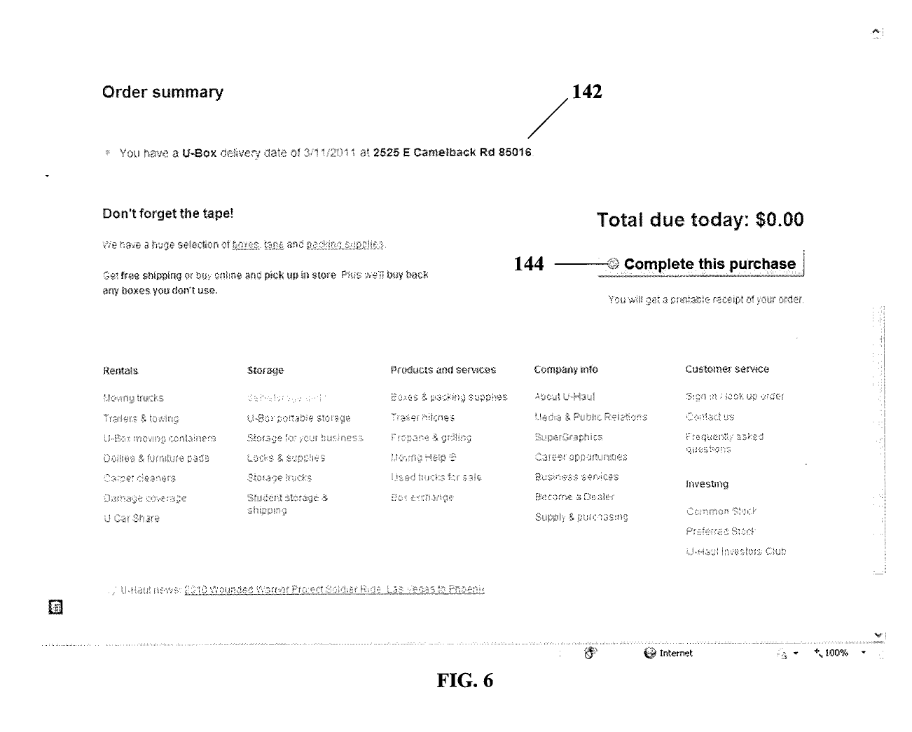

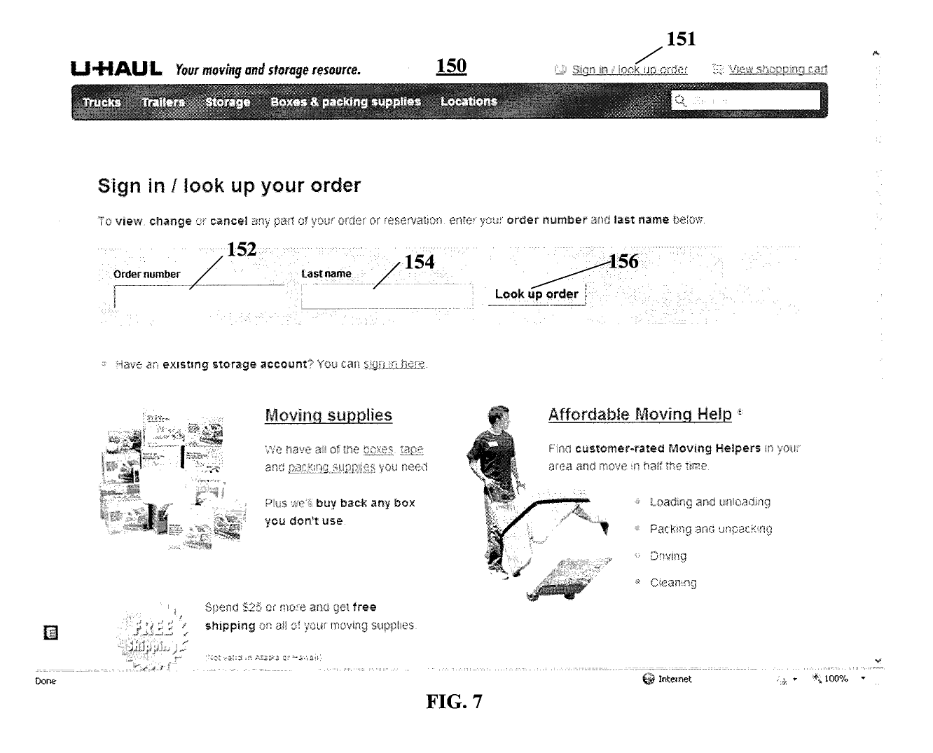

As shown in FIG. 4, the Reservation page 110 includes a Date field 112 for entry of a desired storage container delivery date, a Quantity field 114 into which the customer 13 can enter the desired number of portable storage containers, and a Damage Coverage field 116 with which the customer 13 can choose an insurance option or decline insurance. The Reservation page 110 also includes a Delivery Options section 118, with which the customer 13 can choose a desired delivery option. As shown in FIG. 4, in a preferred embodiment, the customer 13 can choose to have an empty storage container delivered to the delivery address for loading or they can load the storage container at a container staging site. For a loaded container, the customer can request that a delivery truck pickup the container for delivery to a shipping address or to a container staging site. After selecting the desired delivery option, the customer can select the Continue button 126 to cause the system to display a Shopping Cart page 130 like that shown in FIG. 5, which displays the delivery and shipping address information 132 entered by the customer. When the customer 13 selects a Checkout button 134 on this page, the system displays a Checkout page 140 like that shown in FIG. 6, which includes a summary of the customer's order 142. After providing information for online payment, the customer can complete their purchase by selecting Complete Purchase button 144 on the Checkout page 140, and the customer's order information is saved in the database 30 and is associated with an order number. The customer 13 can then view their order by selecting a Look Up Order link 151, which causes the system to display a Look Up Order page 150, as shown in FIG. 7. The Look Up Order page 150 includes an Order Number field 152 and a Last Name field 154. Using this page, the customer can view, change or cancel an existing order by entering the appropriate information in these fields and selecting a Look Up Order button 156.

### Administrator Interface

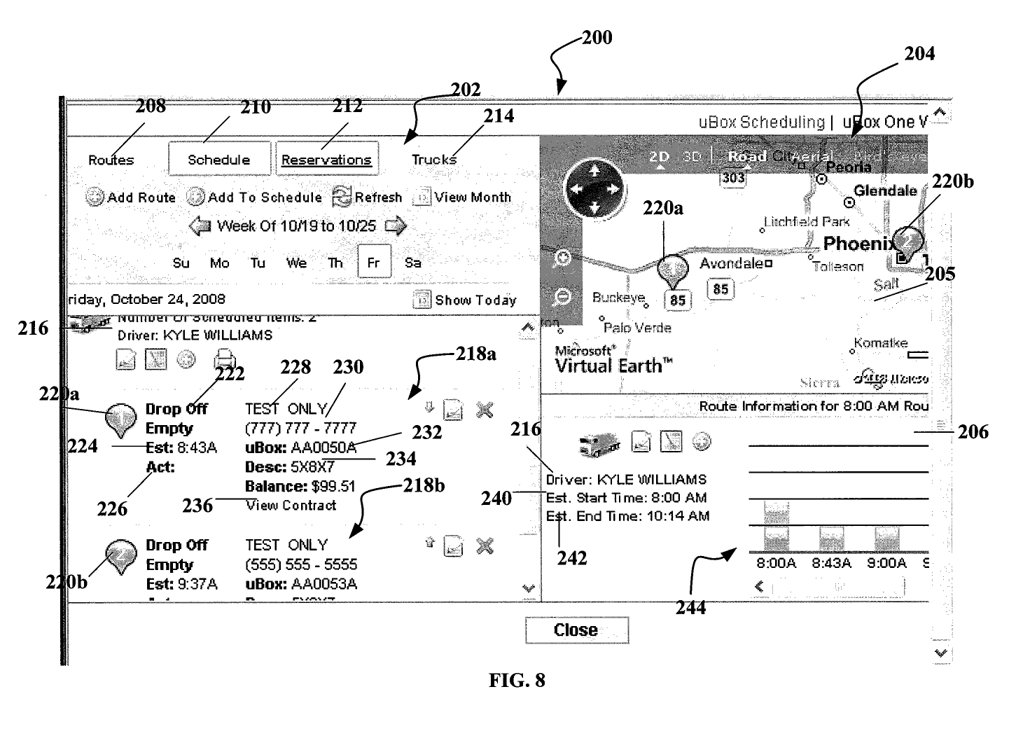

FIG. 8 shows an exemplary embodiment of a screen display of a Mobile Storage Scheduling page 200 for use by an administrator or dispatcher in scheduling deliveries and pickups of portable storage containers into truck routes. The administrator or dispatcher can use the Mobile Storage Scheduling page 200 to view information stored in the database 30 relating to reservations, routes and scheduling such as that as shown in FIG. 8, and to add or delete an event (i.e., a container drop-off or pick-up) to a route schedule. The Mobile Storage Scheduling page 200 includes a Route Scheduling section 202 for creating route schedules, a Route Map section 204 for displaying a map 205 of the of the route currently being viewed, a Route Timeline section 206 for displaying information on the capacity of the delivery truck during the route being viewed. The Route Scheduling section 202 includes various links for viewing reservation, route and scheduling information stored in the database 30, including a Routes link 208 for viewing and adding routes, a Schedule link 210 for viewing and managing deliveries and pickups on a route, a Reservations link 212 for viewing customer reservations, and a Trucks link 214 for viewing and assigning delivery trucks to routes.

As shown in FIG. 8, information associated with route includes an assigned Driver 216 and scheduled tasks 218. Information associated with each of the tasks include a transaction number 220, a task description 222, an estimated time for the scheduled task 224, an actual time that the task is completed 226, customer name 228, a customer telephone number 230, a portable container identifier 232, a description of the portable container size 234 and a View Contract link 236. For each task, the transaction number 220 is displayed on the map at the location of the delivery or pickup address for that task. The Route Timeline section 206 displays the number of portable storage containers that are on the truck during the course of the route. For example, for the route displayed in FIG. 8, the total capacity of the assigned truck is four portable containers, and each box shown in the timeline graph represents one container. Thus, the timeline graph in the Route Timeline section 206 reflects that at 8:00 AM, the truck will have two containers on board, and at 8:43 AM, after dropping of one of the empty containers, the truck will have one container remaining on board.

### Mobile User Interface

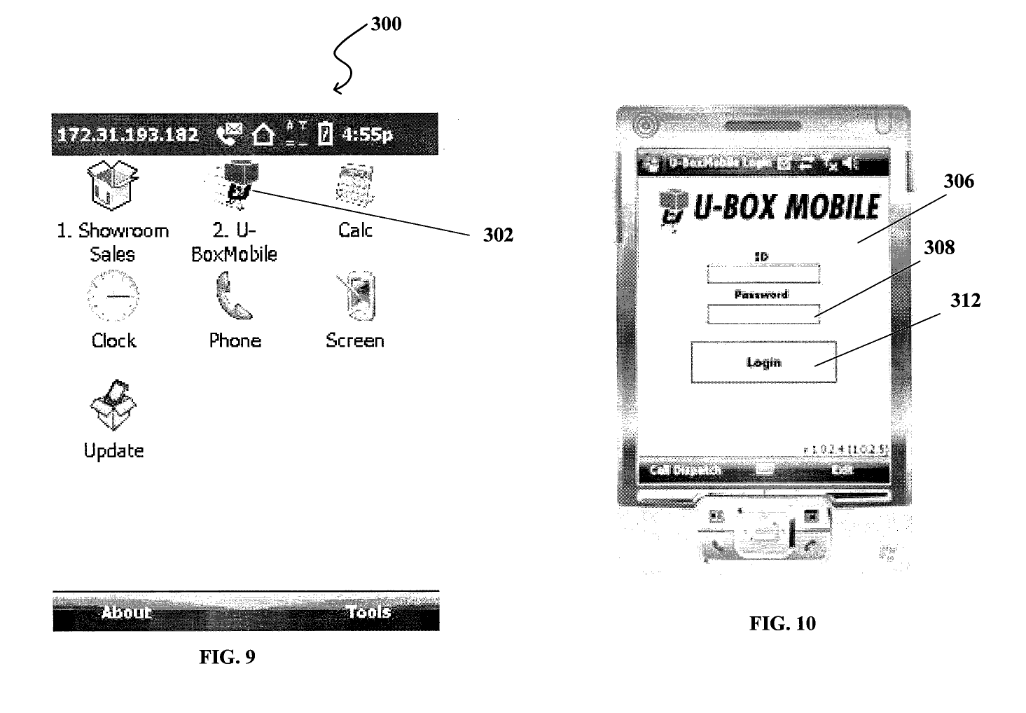

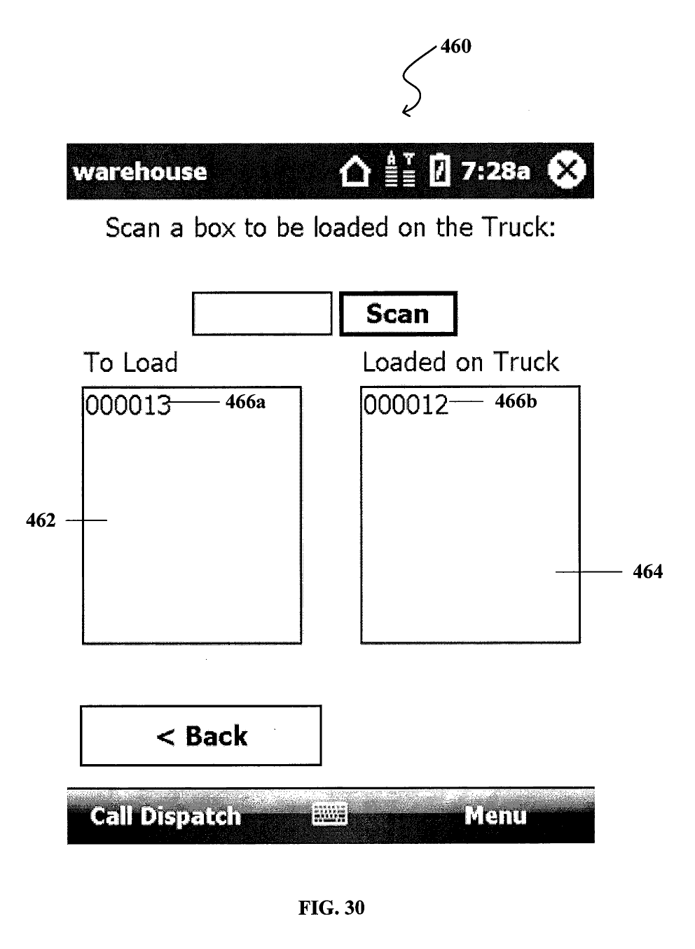

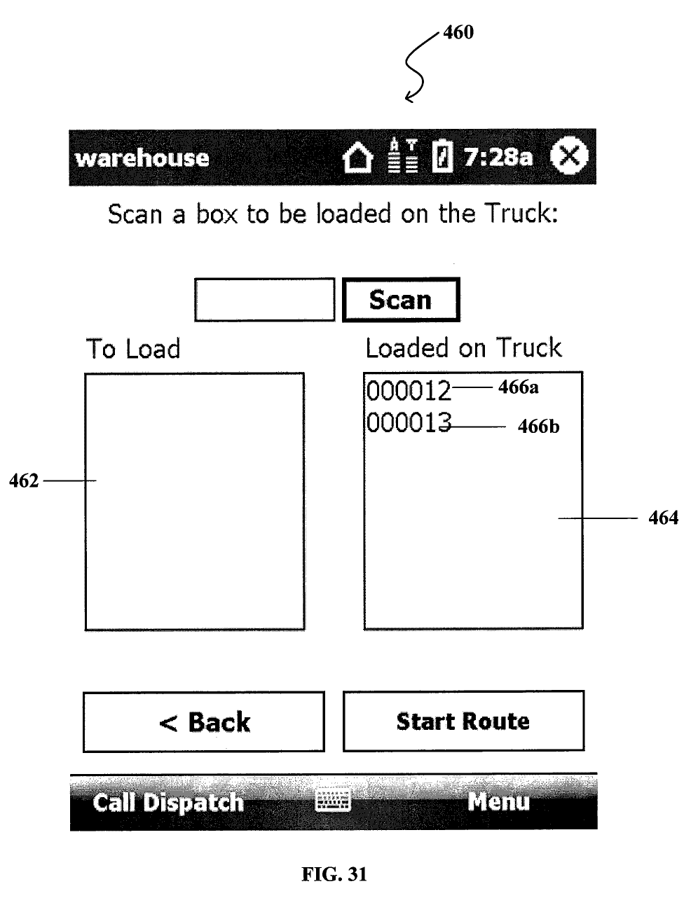

Referring to FIGS. 9-35, the functionality and operation of the mobile computer device 11 will now be illustrated in connection with a more detailed description of the user interface of the mobile computer device 11.

FIG. 9 shows an exemplary Applications Menu page 300 displayed on the screen of the mobile computer device 11. From this page, a user 12 (such as a driver or mobile storage representative) can launch the mobile storage application 40 (step 50) by selecting a mobile storage application icon 302. In response, the mobile computer device displays a Login Page 306, such as that shown FIG. 10. The user 12 can login to the mobile storage management application 32 of the self-storage management computer system 16 by entering the user's ID into an ID field 308, entering the user's password into a password field 310, and selecting the Login button 312. If the user can log into the self-storage management computer system 16 in different capacities with different authorizations, e.g. as a driver or as a developer, the mobile computer device 11 will display a Login Selection page 306, as shown in FIG. 11. After highlighting the proper capacity, the user 12 can choose a Select User icon 314 to complete the login request.

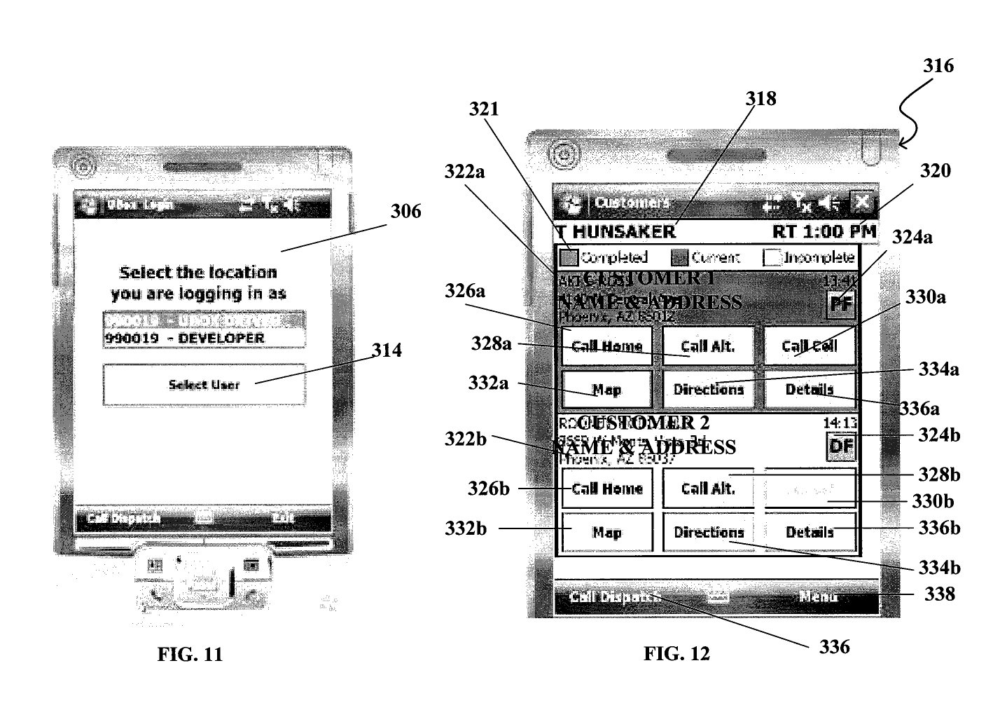

After the self-storage management computer system 16 validates the user's login (step 52), it downloads customer data to the mobile computer device 11 (step 58) and the user 12 is prompted to begin a mobile storage customer route. In one preferred embodiment, as shown in FIG. 12, the mobile computer device 11 displays a Customers Main page 316, which shows the user's scheduled deliveries and pickups for customer on the displayed route. In the preferred embodiment of FIG. 12, only routes that are assigned to the logged-in user 318 and that are scheduled for the current day (including associated customer names and addresses) are displayed. For example, in FIG. 12, the credentials used to login to the self-storage management computer system 16 are associated with user T. Hunsaker, and the self-storage management computer system 16 has downloaded only the information for the route assigned to T. Hunsaker.

Still referring to FIG. 12, a route time display 320 indicates the departure time that the driver is scheduled to leave the warehouse. Customer name and address information 322a, 322b is displayed for each customer in the order that they have been scheduled by the dispatcher or administrator using the Mobile Storage Scheduling page 200. For each customer 322a, 322b, a task code icon 324a, 324b indicates what is scheduled to occur at the customer's address. The task codes can include, for example, the following:

PF-Pickup Full

DF-Deliver Full

PE-Pickup Empty

DE-Deliver Empty

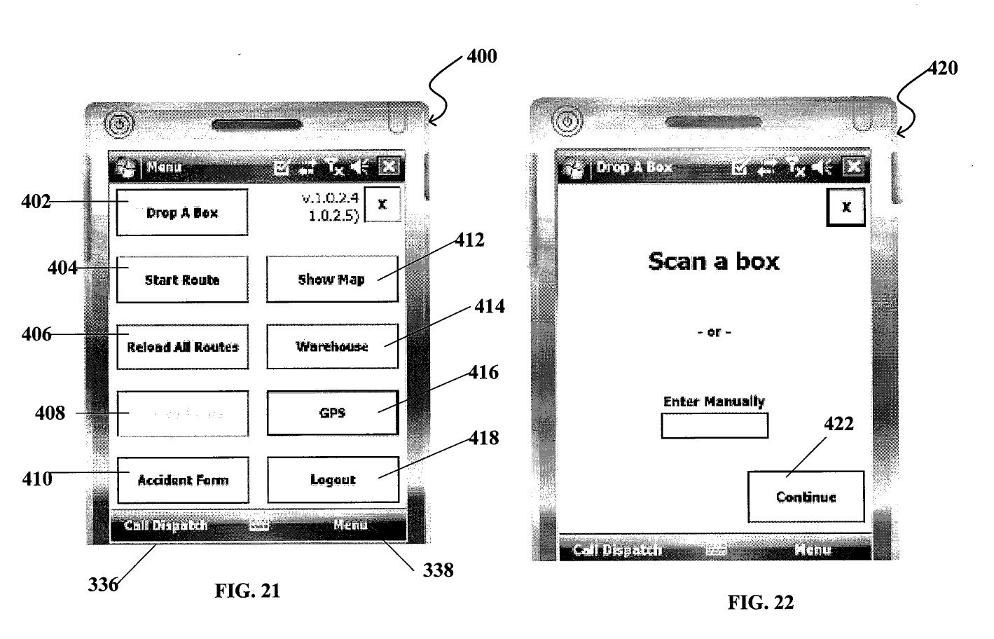

A Call Dispatch icon 336 and a Menu icon 338 are preferably always accessible from the bottom of the Customer Main page 316. Selecting the Call Dispatch icon 336 causes the mobile telephone 50 of the mobile computer device 11 to call the mobile storage dispatcher or home office. Selecting the Menu icon 338 causes the mobile computer device 11 to display the Menu page shown in FIG. 21.

As shown in FIG. 12, for each listed customer, the Customer Main page 316 also includes a Call Home icon 326, a Call Alt. icon 328, a Call Cell icon 330, a Map icon 332 and a Directions icon 334. These icons provide the user 12 with the following functionality.

Call Customer. The user 12 can conveniently call a selected customer (step 66). If the user selects the Call Home icon 326, the mobile computer device 11 automatically causes the mobile telephone 50 to dial the home phone number that the customer has provided. This can be used, for example, to notify the customer that their mobile storage container is in route. If the user selects the Call Alt. icon 328, the mobile computer device 11 automatically causes the mobile telephone 50 to dial an alternative phone number that the customer has optionally provided. If the user selects the Call Cell icon 330, the mobile computer device 11 automatically causes the mobile telephone 50 to dial mobile phone number that the customer has optionally provided. For example, if the customer cannot be reached on their home phone, the user 12 can call the customer's cell phone by selecting the Call Cell icon 330, or the user 12 can call an alternative telephone number provided by the customer by selecting the Call Alt icon 328. As shown in FIG. 12, if a customer has not provided a cell telephone number or an alternative telephone number, the relevant icon will be grayed out, showing that the function is not available (see, for example, icon 330b).

Map. If the user 12 selects the Map icon 332, the mobile computer device 11 displays a static map (not shown) (step 62) of the recommended route between the driver's origination point (whether the warehouse or a previous customer) and the current customer.

Directions. If the user selects the Directions icon 334, the mobile computer device 12 displays turn-by-turn directions from the present location of the mobile device to the next customer's address.

Again referring to FIG. 12, in the Customer Main page 316 also includes a Details icon 336, which the user 12 can select (step 68) to access options relating to the customer's transaction. In addition to being able to contact the customer (step 88), the user 12 can access functions for obtaining customer signatures (steps 72-74), making comments and notes relating to the customer's transaction (steps 76-80), capturing and storing images of the mobile storage container, the customer's property and any damage (steps 82-86), scanning portable storage containers (step 90) and completing a scheduled delivery or pickup (step 92).

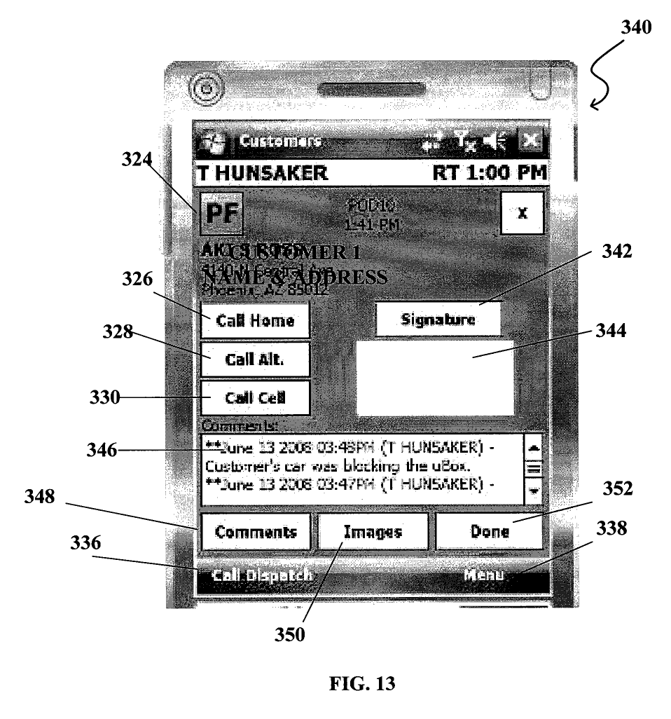

When the user selects the Details icon 336, the mobile device 11 displays a Customer Details page 340, as shown in FIG. 13. The Customer Details page 340 includes a Call Home icon 326, a Call Alt. icon 328, a Call Cell icon 330, a Call Dispatch icon 336 and a Menu icon 338, all of which function as previously described. In addition, the Customer Details page 340 includes a Signature icon 342, a Signature display 344, a Comments display, a Comments icon 348, an Images icon 350 and a Done icon 352, which provide the user 12 with the following functionality.

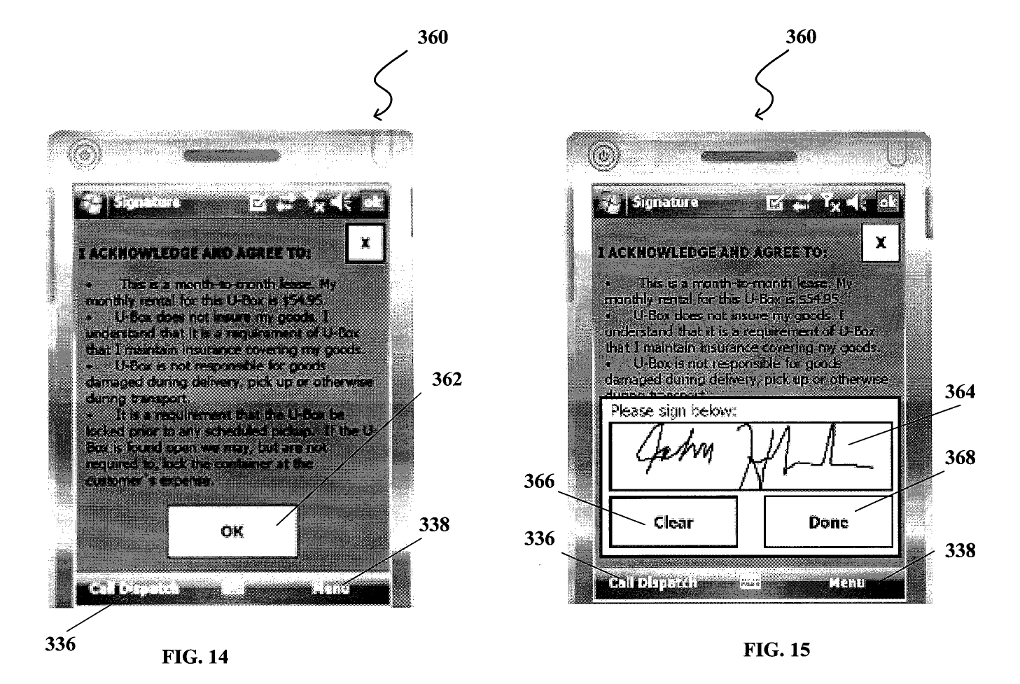

Signature. After a storage container is placed where the customer indicates, the delivery person can obtain the customer's signature. To do so, the user selects the Signature icon 342 on the Customer Details page 340, as shown in FIG. 13. This causes the mobile computer device 11 to display a Customer Acknowledgment page 360, as shown in FIG. 14. The Customer Acknowledgment page 360 displays terms and conditions 361 that the customer is required to review and acknowledge in connection with the transaction. For example, the displayed terms and conditions 361 can outline the agreed-upon monthly rate and the selected insurance option. (In the example of FIG. 14, the customer has chosen not to insure his goods). The terms and conditions can also indicate that the storage container provider is not responsible for damage to contents due to load shift and that the customer is obligated to lock their storage container before a scheduled pickup. To agree to the terms and conditions, the customer selects an OK button 362, which causes the mobile computer device 11 to display a signature field 364 with a Clear icon 366 and a Done icon 368, as shown in FIG. 7. After the customer signs their name in the signature field 364 (e.g., using a stylus), they select the Done icon 368 to cause the mobile computer device 11 to save the signature and return to the Customer Details page 340. The saved signature will then appear in the Signature display 344 of the Customer Details page 340, as shown in FIG. 24.

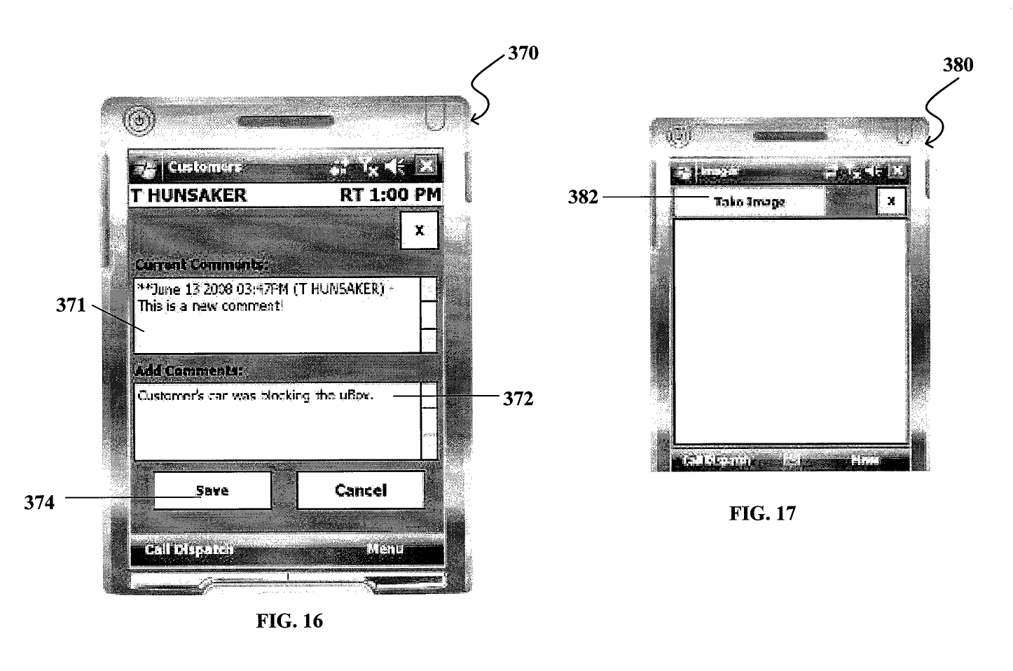

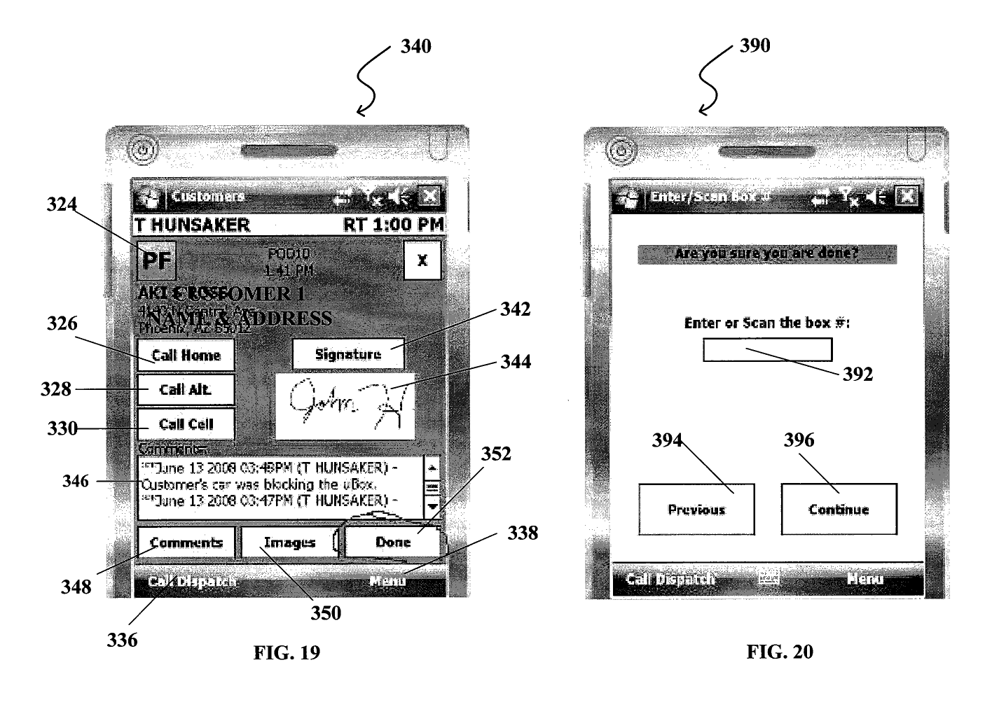

Comments. Referring again to FIG. 13, if notes need to be associated with a customer or the customer's transaction, the user can do so by selecting the Comments icon 348, which causes the mobile computer device 11 to display a Comments Page 370, as shown in FIG. 16. The Comments page 370 includes a Current Comments field 371, which displays comments that have previously been added. With either a physical keyboard or on-screen keyboard of the mobile computer device 11, the user can add any desired notes or comments into an Add Comment field 372. When the comments are complete, the user 12 select the Save icon 374, which causes the mobile computer device 11 to save the comments and return to the Customer Details page 340. The saved comments will then appear in the comment display 346 of the Customer Details page 340, as shown in FIGS. 13 and 19. According to a presently preferred method, once comments have been saved, the user 12 cannot delete them from the customer's transaction record. Preferably, the Comments page 370 should be used liberally to include any relevant information, including follow-up dates, items purchased, unusual storage container placement, etc.

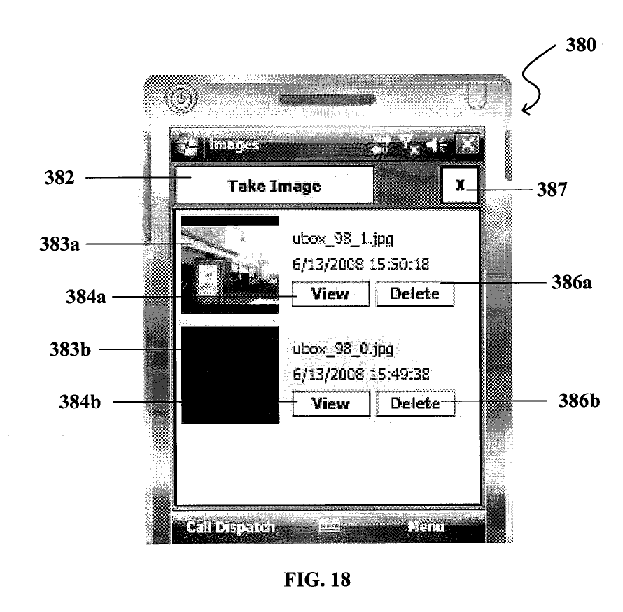

Images. Referring again to again to FIG. 13, the user can take digital photographic images with the causes the mobile computer device 11 by selecting the Images icon 350. Preferably, the user should take at least one image of the portable storage container on the customer's property. More than one is recommended. Selecting the Images icon 350 causes the mobile device 11 to display the Images page 380 shown in FIG. 17, which includes a Take Image icon 382. The user can take a digital image with the camera of the mobile computer device 11 by pressing the Take Image icon 382, pointing the camera lens at the desired location and pressing the “carriage return” button on the physical keyboard. After an image 383 has been taken, a thumbnail of the image will be displayed on the Images page 380 along with the image filename and date and time of creation, as shown in the example of FIG. 18. To take multiple images, the user can again select the Take Image icon 382 displayed on the Images page 380. To view a full-screen display of a thumbnail image 380, the user 12 can select a View icon 384 next to the desired image. To delete an image, the user 12 can select a Delete icon 386 next to the desired image. When all of the desired images 383 are taken, the user can exit the Images page 380 by selecting the X icon 387, which causes the mobile computer device 11 to return to the Customer Details page 340.

Completing the Transaction. Referring to FIG. 19, after all transaction comments, signatures, and images have been completed, the user 12 can finalize the transaction by selecting the Done icon 352 on the Customer Details page 340. This causes the mobile computer device 11 to display an Enter/Scan Box No. page 390, as shown in FIG. 20. The user 12 can use the barcode scanner 44 of the mobile computer device 11 to scan a barcoded number on the subject portable storage container into a Box No. field 392 or can enter the number manually into the Box No. field 392. After the container number is entered, the user 12 can press a Continue icon 396 to complete the scheduled transaction and upload the transaction information to the mobile storage management computer system 16. In a presently preferred embodiment, the user 12 cannot not add comments or take additional images once the transaction is complete. To add comments or images before that may have been inadvertently omitted, the user 12 can select a Previous icon 394 to exit the Enter/Scan Box No. page 390 without finalizing the present transaction and return to the Customer Details page 340.

When a customer's transaction is completed, the mobile computer device 11 will automatically display the Customer Main Page 316, as shown in FIG. 12, and will update the status of the transaction by changing the background color of the transaction based on a color-coding chart 321. For example, the color coding for the customer transactions shown in the Customer Main Page 316 of FIG. 12 is as follows:

Completed customer transactions are gray.

Current customer transactions are blue.

Subsequent customer transactions are white.

To complete a scheduled route, the user 12 repeats the previously described process for each of the remaining customers shown on the route. After the scheduled route is completed and the user 12 has returned to the portable storage warehouse, he or she must log out of to the mobile storage management application 32. To do so, the user 12 can select the Menu icon 338 to access the logout function described below.

Referring again to FIGS. 12-20, selecting the Menu icon 338 causes the mobile computer device 11 to display a Menu page 400, such as that shown in FIG. 21. The Menu page 400 includes a Drop a Box icon 402, a Start Route icon 404, a Reload All Routes icon 406, Select Route icon 408, an Accident Form icon 410, a Show Map icon 412, a Warehouse icon 414, a GPS icon 416 and a Logout icon 418, which provide the user 12 with the functionality described below.

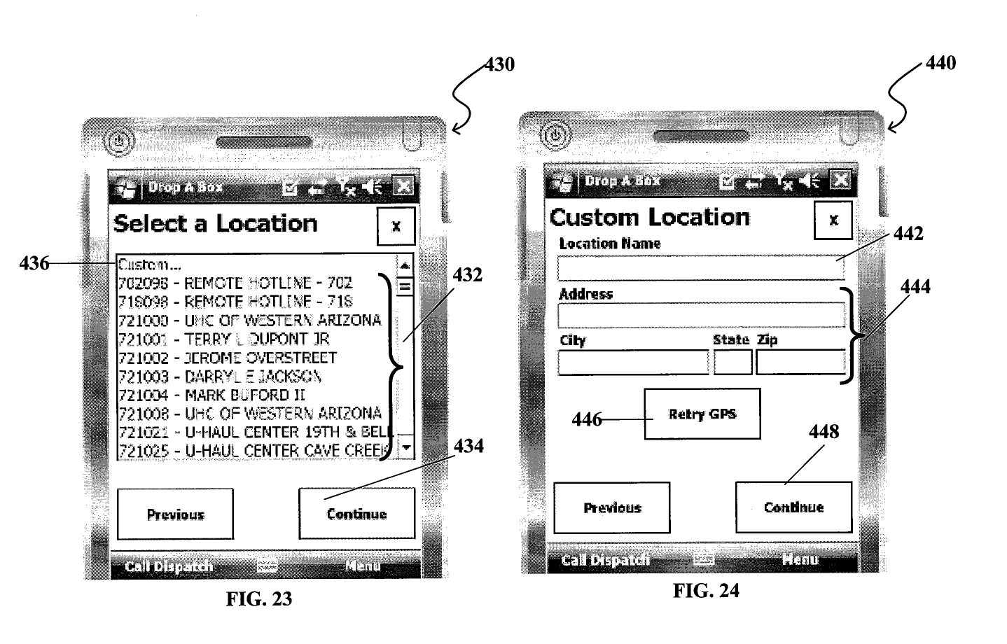

Drop a Box. The Drop-a-Box feature can be used to track the location of portable storage containers in the field that are not assigned to a specific customer. This feature allows the user 12 to track portable storage containers placed in locations in the user's service area other than at a customer's location. Referring to FIG. 21, the user 12 activates this feature by selecting the Drop a Box icon 402, which causes the mobile computer device 11 to display a Drop a Box page 420, as shown in FIG. 22. From this page, the user can scan a bar-coded identifier on the portable storage container that he or she is working with or can manually enter the identifier. After doing so, the user can press a Continue icon 422, which will cause the mobile computer device 11 to display a Select Location page 430, as shown in FIG. 23, which includes a list 432 of predefined locations such as a storage warehouse in the driver's service area. The user 12 can highlight the location where he or she is dropping the container and press a Continue icon 434 to store the location of the storage container. If the user is staging a portable storage container at a location that is not in the predefined locations, the user can select a Custom option 436 and select the Continue icon 434. In response, the mobile computer device 11 will display a Custom Location page 440, as shown in FIG. 24. Custom Location page 440 includes a Location Name field 442 for describing the custom location and location address fields 444. With its GPS function, the mobile computer device 11 will automatically attempt to input the address information into the location address fields 444. If it is unable to do so, the user 12 can select a Retry GPS icon 446 or can manually enter the physical address of the storage container. When all fields are completed, the user 12 can select a Continue icon 448 to update the record.

Start Route. Referring again to FIG. 21, the user can select the Start Route icon 404 to manually begin a route, which causes the mobile computer device 11 to display the Customers Main page 316, like that shown in FIG. 12.

Reload All Routes. The user 12 can select the Reload All Routes icon 406 to manually refresh the user's route information from the mobile storage management computer system 16 in the event changes have been made to the to the schedule.

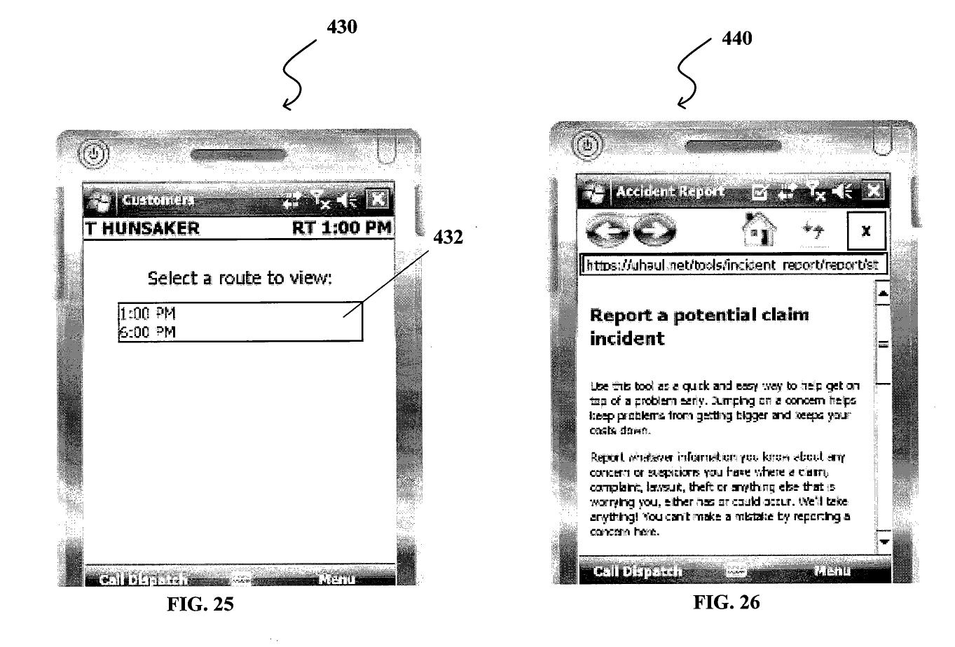

Select a Route. If more than one route is assigned to the user 12 on a given day, he or she can choose the Select Route icon 408 to select the route that he or she would like to work. This causes the mobile computer device 11 to display a Select a Route page 420, as shown in FIG. 25, with a route list 432. When the user 12 selects one of the listed routes, the mobile computer device 11 displays the Customers Main page 316 (see FIG. 12) with information for the selected route.

Accident Form. The Accident Form feature can be used to link directly to an online incident reporting form for the reporting of incidents involving portable storage containers or the delivery vehicle. Selecting the Accident Form icon 410 causes the mobile computer device 11 to display such a form on an Accident Reporting page 440, like the example shown in FIG. 26. In a presently preferred embodiment, the Accident Reporting page 440 prompts the user 12 to input a separate ID and password for the online incident reporting function.

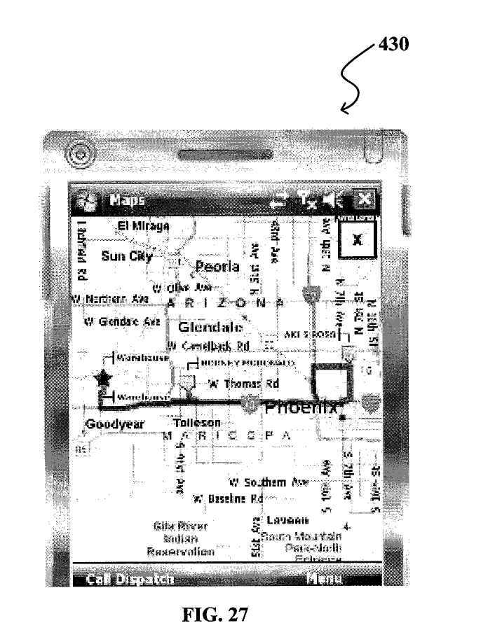

Show Map/GPS. Referring again to FIG. 21, the user 12 can select the Show Map icon 412 to display a Route Map page 430 like the example shown in FIG. 27. The Route Map page shows a static map of the route of the current day's schedule. The user 12 can select the GPS icon 416 to display a similar map with an icon that marks the current location of the mobile computer device 11.

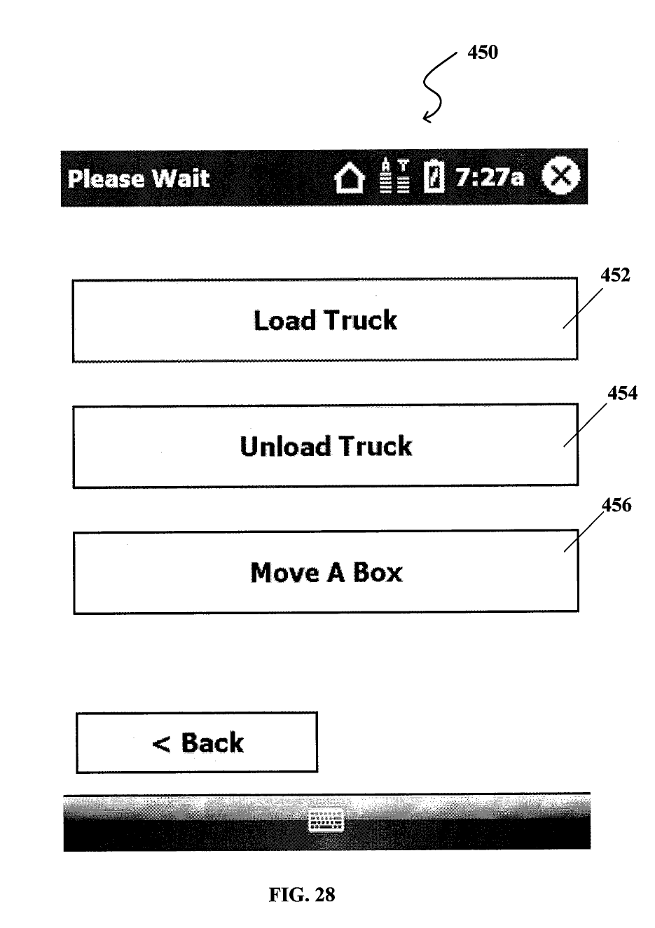

Warehouse. The Warehouse feature can be used to facilitate tracking of the loading, unloading and moving of portable storage containers. The user 12 activates this feature by selecting the Warehouse icon 414, which causes the mobile computer device 11 to display a Warehouse Menu page 450, as shown in FIG. 28. The Warehouse Menu page 450 includes a Load Truck icon 452, an Unload Truck icon 454 and a Move a Box icon 456.

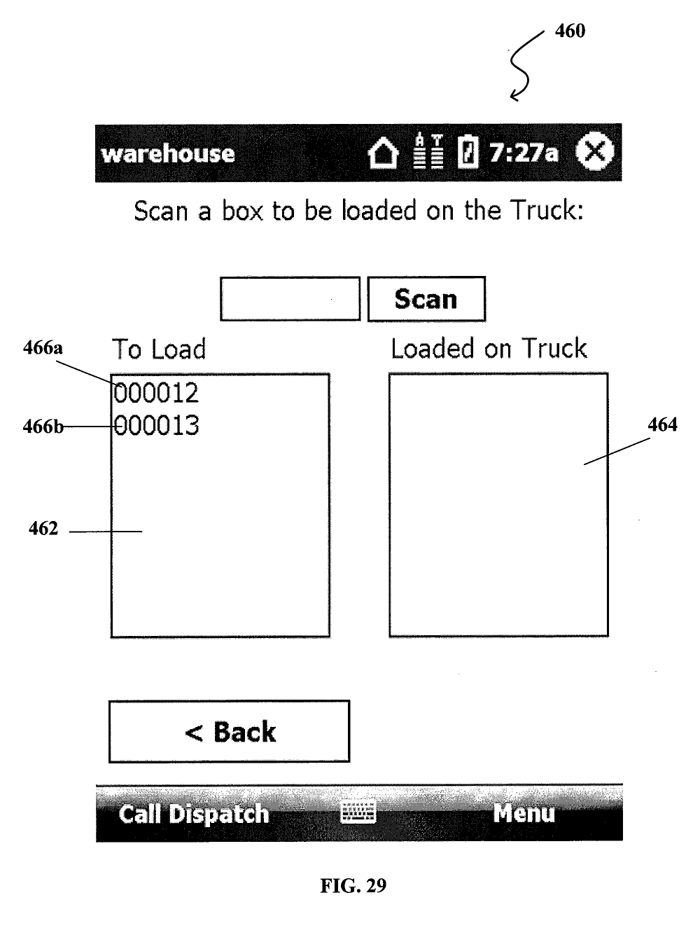

When the user selects the Load Truck icon 452, the mobile computer device 11 displays a Scan Box to Be Loaded page 460, as shown in FIG. 29. From this page, the user 12 can scan a bar-coded identifier on the portable storage containers to be loaded on the assigned truck. The Scan Box to Be Loaded page 460 includes a To Load display 462 and a Loaded on Truck display 464. As the user scans the bar-coded identifiers 466 (or manually enters the identifiers) of the portable storage containers to be loaded, the identifiers 466 are listed in the To Load Display. As the containers are loaded on the truck, the user selects the associated identifier 466 and the mobile computer device 11 moves that identifier to the Loaded on Truck display 464, as illustrated in FIGS. 29-31.

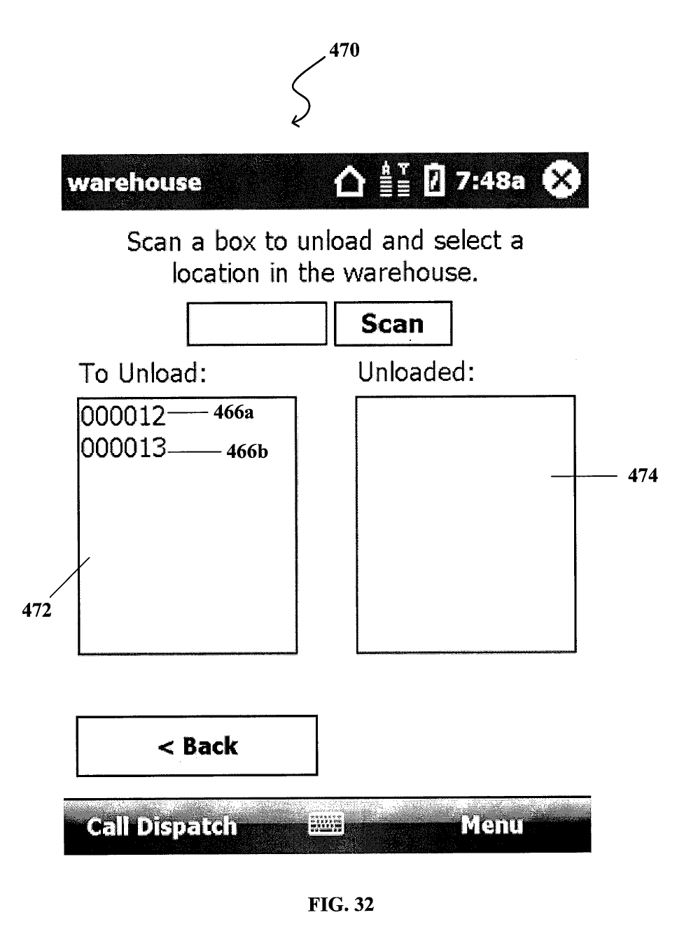

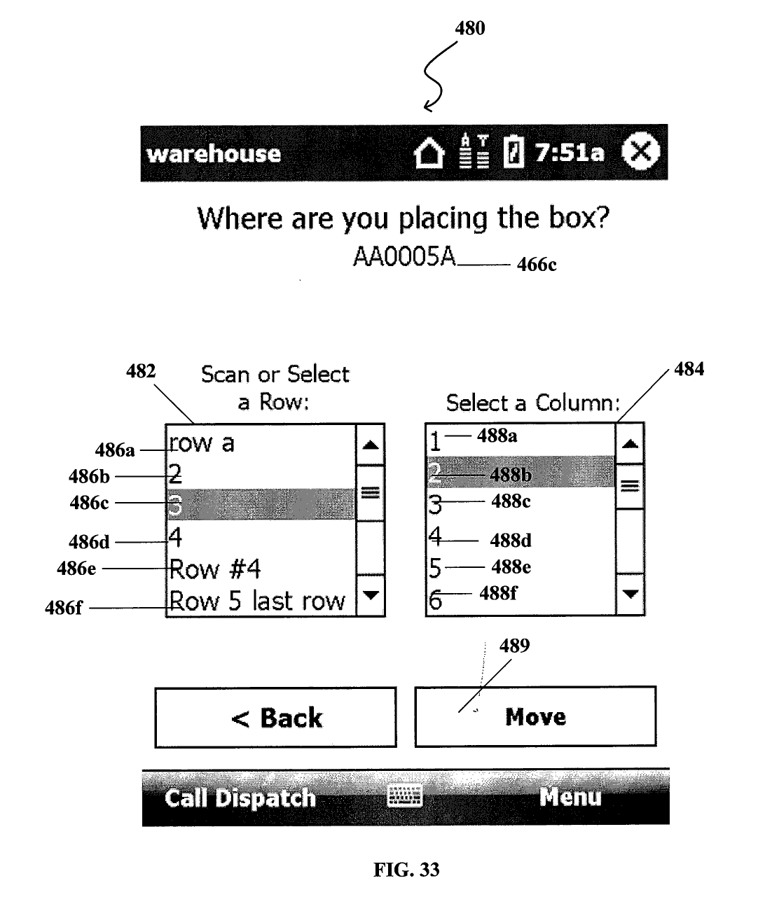

When the user selects the Unload Truck icon 454, the mobile computer device 11 displays a Scan Box to Unload page 470, as shown in FIG. 32. From this page, the user 12 can scan a bar-coded identifier on the portable storage containers to be unloaded from the truck. The Scan Box to Unload page 470 includes a To Unload display 472 and an Unloaded display 474. As the user 12 scans the bar-coded identifiers 466 (or manually enters the identifiers) of the portable storage containers to be loaded, the identifiers 466 are listed in the To Unload display 472. When the user 12 selects an identifier 466c from the To Unload display 472, the mobile computer device 11 displays a Warehouse Location page 480 as shown in FIG. 33. Warehouse Location page 480 includes a Select Row display 482, which displays the row identifiers 486 of locations in the warehouse where the portable storage container can be placed, and a Select Column display 484 which displays column identifiers 488 for available locations in the row that the user 12 has selected by highlighting its identifier in the Select Row display 482. When the storage container is moved to the selected physical column/row location within the warehouse location, the user 12 can select a Move icon 489 to update the warehouse space inventory information stored by the self-storage management computer system 16.

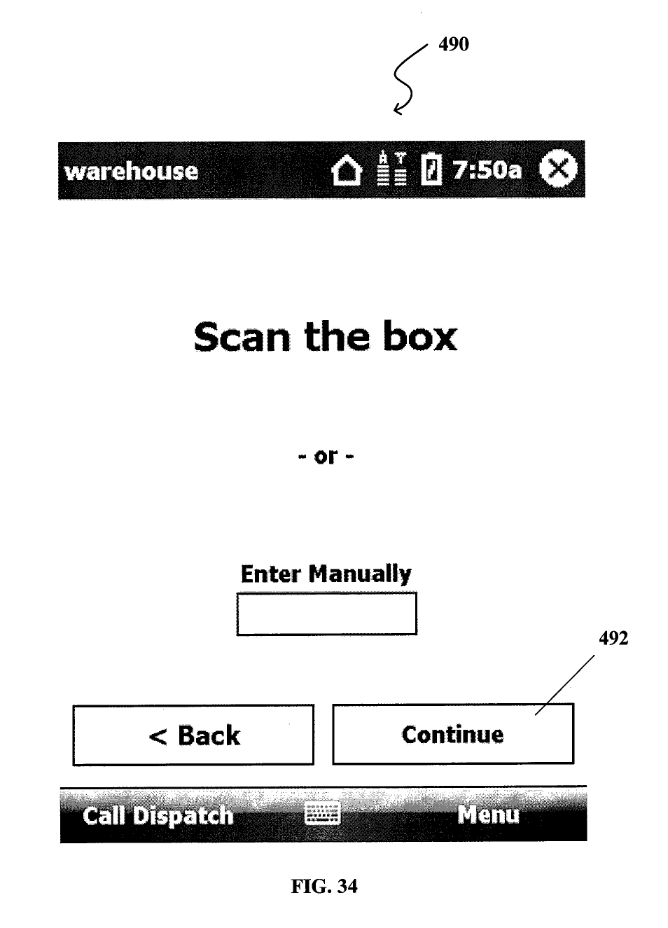

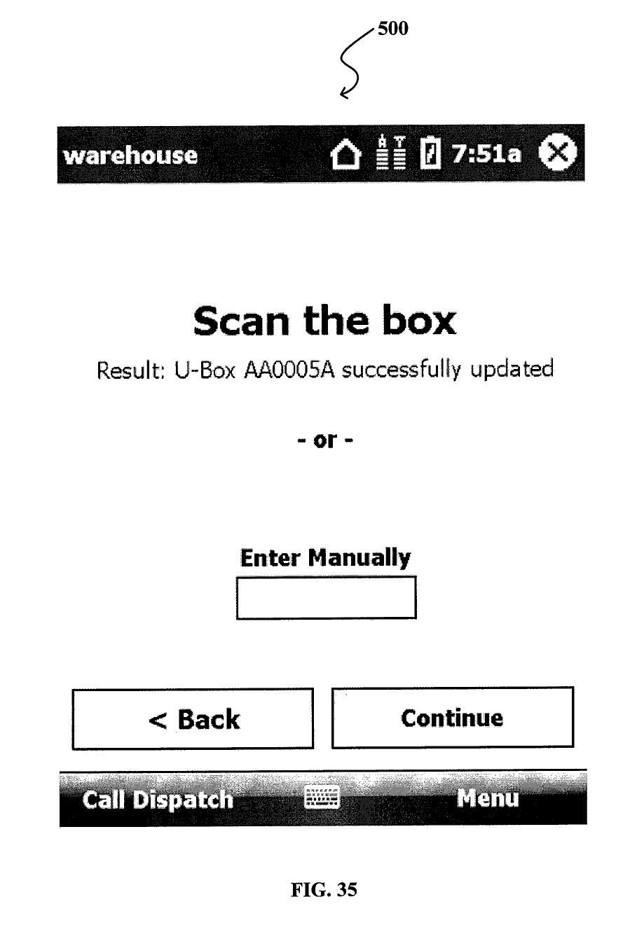

Referring again to FIG. 28, to move a container within the warehouse, the user 12 selects the Move a Box icon 456, which causes the mobile computer device 11 to display a Scan Box page 490, as shown in FIG. 34. The Scan Box page 480 operates similar to the Drop a Box page 420 previously described above (see FIG. 22); except that when the user 12 selects the Continue icon 492 on the Scan Box page 490, the mobile computer device 11 displays the Warehouse Location page 380 (see FIG. 33) which operates as described above. When the storage container is moved to the selected physical column/row location within the warehouse location, the user 12 can select a Move icon 489 to update the warehouse space inventory information stored by the self-storage management computer system 16 and the mobile computer device 11 displays a Successful Move page 500, as shown in FIG. 35, which notifies the user that the warehouse space inventory information has been successfully updated.

Logout. Referring back to FIG. 21, the user 12 can select the Logout icon 418 to log out of the mobile storage application 40.

Upon reading this disclosure, those skilled in the art will appreciate that various changes and modifications may be made to the preferred embodiments of the invention and that such changes and modifications may be made without departing from the spirit of the invention. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for managing and providing mobile storage services, the method comprising:
using a mobile computer device to display to a delivery vehicle driver route information relating to the delivery or pickup of a portable storage container, wherein the route information includes:
contact information associated with a customer on the route, including a customer address for delivery of the storage container;
a task associated with the customer;
a task status associated with customer; and
map information including information showing the location of the customer address;
using the mobile computer device to display for the customer contract information related to the task;
using the mobile device to capture a signature of the customer to acknowledge the customer's agreement to the displayed contract information;
using the mobile device to capture comments relating to the task;
using the mobile device to capture images related to the task;
using the mobile device to capture a container identifier associated with the portable storage container; and
using the mobile device to capture a location associated with the container identifier.

2. The method of claim 1 further comprising using the mobile computer device to transmit the signature of the customer, the comments relating to the task, the images relating to the task, and the location associated with the container identifier to a centralized database for storing route information for a plurality of drivers and a plurality of routes.

3. The method of claim 1 wherein the container identifier is captured using a barcode scanner.

4. The method of claim 1 wherein the location associated with the container identifier is captured using a global positioning system.

5. The method of claim 1 wherein the map information further includes information showing the location of the mobile computer device.

6. The method of claim 1 further comprising using the mobile computer device to access an accident form for reporting incidents involving the portable storage container or the delivery vehicle.

7. A computer network system for managing and providing mobile storage services, the system comprising:
a database for storing route information relating to a plurality of delivery vehicle routes for the delivery or pickup of portable storage containers, wherein the route information includes:
contact information associated with a plurality of customer on the deliver vehicle routes, including a plurality of customer addresses for delivery of a portable storage container;
a task associated with each of the plurality of customers;
a task status associated with each of the plurality of customers; and
map information including information showing the location of each of the plurality of customer addresses;
a mobile computer device in communication with the database for displaying to a delivery vehicle driver route information relating to a route assigned to the delivery vehicle driver including:
contact information associated with a customer on the route assigned to the delivery vehicle driver, including a customer address for delivery of the storage container;
a task associated with the customer on the route assigned to the delivery vehicle driver;
a task status associated with customer on the route assigned to the delivery vehicle driver; and
map information including information showing the location of the customer address.
